(19) United States
(12) Patent Application Publication
(10) Pub. No.: US 2026/0140481 A1
(43) Pub. Date: May 21, 2026

(54) CLOCK CONTROL SYSTEM

(71) Applicant: Zhangzhou Tongyuan Electronic Co., Ltd, Zhangzhou (CN)

(72) Inventor: Mingyuan Li, Xiamen (CN)

(21) Appl. No.: 18/955,861

(22) Filed: Nov. 21, 2024

(51) Int. Cl. G04G 13/00; G06F 3/16; H05B 47/16

(52) U.S. Cl. CPC G04G 13/00; H05B 47/16

(57) ABSTRACT

Disclosed is a clock control system, including a circuit board, where the circuit board is provided with a control unit, further including a pointer unit, a pointer driving unit, a trigger unit, a light-emitting unit, and a power supply unit, where the pointer driving unit is mechanically connected or inductively connected to the pointer unit and the trigger unit, to control the rotation of pointers on the pointer unit and trigger the trigger unit at nodes of integral hours, the light-emitting unit is electrically connected to the control unit through a light-emitting circuit on the circuit board, and the power supply unit supplies power to the control unit and the light-emitting unit through a power supply circuit on the circuit board.

### TECHNICAL FIELD

The present disclosure relates to the technical field of clock control, and particularly relates to a clock control system.

### BACKGROUND

A clock is a timing device and also a precise instrument for measuring and indicating time. The clocks are usually distinguished by sizes of their inner machines. According to international conventions, a clock has a movement diameter of greater than 80 mm and a thickness of greater than 30 mm, a pocket watch has a diameter of 37-50 mm and a thickness of 4-6 mm, a wrist watch has a diameter of less than 37 mm, and a lady's watch has a diameter of not greater than 20 mm or a movement area of not greater than 314 mm². The wrist watch is one of the smallest, most durable, and most precise mechanical device invented by humans.

Many existing clocks have a function of chiming the hour, that is, at each node of an integral hour, the clock unit controls a chime to give a sound alarm, to remind the user that time reaches a node of an integral hour. However, when the user is resting or sleeping at this time, a sound of on-time alarm will disturb the user's rest or sleep, thus bringing a poor user experience.

### SUMMARY

An objective of the present disclosure is to provide a clock control system to solve the problem of disturbing the user's rest or sleep mentioned in the above Background.

To achieve the above objective, the present disclosure adopts the following technical solution:

a clock control system, including a circuit board, where the circuit board is provided with a control unit, further including a pointer unit, a pointer driving unit, a trigger unit, a light-emitting unit, and a power supply unit, where the pointer driving unit is mechanically connected or inductively connected to the pointer unit and the trigger unit, to control the rotation of pointers on the pointer unit and trigger the trigger unit at nodes of integral hours, the light-emitting unit is electrically connected to the control unit through a light-emitting circuit on the circuit board, and the power supply unit supplies power to the control unit and the light-emitting unit through a power supply circuit on the circuit board.

In an embodiment, the clock control system further includes a light sensing unit, and the light sensing unit is electrically connected to the control unit.

In an embodiment, the clock control system further includes a sound prompt unit, and the sound prompt unit is electrically connected to the control unit.

In an embodiment, the clock control system further includes a control switch, and the control switch is electrically connected to the control unit.

In an embodiment, the light-emitting unit includes one of a monochromatic lamp or a multi-color lamp.

In an embodiment, the trigger unit includes one of a Hall switch, a micro switch, or an optical switch.

In an embodiment, the clock control system further includes a brightness adjustment unit, a signal input terminal of the brightness adjustment unit is connected to a signal output terminal of the control unit, and a signal output terminal thereof is connected to a signal input terminal of the light-emitting unit.

In an embodiment, the light sensing unit includes one of a light-dependent resistor, a diode light sensor, or a transistor light sensor.

In an embodiment, the sound prompt unit includes one of a speaker or a buzzer.

Compared with the prior art, the present disclosure has the beneficial effects as follows:

In the above clock control system, the control unit, the pointer unit, the pointer driving unit, the trigger unit, the light-emitting unit, and the power supply unit are arranged in a matched manner. When the hour pointer and the minute pointer of the pointer unit both point to a node of an integral hour in a matched manner, the pointer driving unit triggers the trigger unit, the trigger unit sends a signal of the integral hour to the control unit, and the control unit then controls the light-emitting unit to emit light. Light reminds users of nodes of integral hours without need to make a sound, thereby avoiding the possibility of disturbing their rest or sleep at night, so that a good user experience is maintained.

### BRIEF DESCRIPTION OF THE DRAWINGS

FIG. 1 is a schematic diagram of a clock control system.

### DETAILED DESCRIPTIONS OF THE EMBODIMENTS

In order to enable the objectives, features, and advantages mentioned above of the present disclosure to be more apparent and easily understood, specific implementations of the present disclosure will be described in detail below with reference to the drawings. Numerous specific details are set forth in the following description to facilitate a thorough understanding of the present disclosure. However, the present disclosure can be implemented in many other ways than those described herein, and those skilled in the art may make similar modifications without departing from the spirit of the present disclosure, and therefore the present disclosure is not to be limited by the specific embodiments disclosed below.

It should be noted that when an element is referred to as being “connected to” another element, the element may be directly connected to another element or there can be a centered element at the same time. On the contrary, when an element is referred to as being “directly” connected to another element, an intermediary element does not exist.

Unless defined otherwise, all technical and scientific terms used herein have the same meaning as commonly understood by those skilled in the art to which the present disclosure belongs. The terms used in the specification of the present disclosure herein are for the purpose of describing specific implementation modes merely and are not intended to be limiting of the present disclosure. The term "and/or" as used herein encompasses any or all combinations of one or more of the associated listed items.

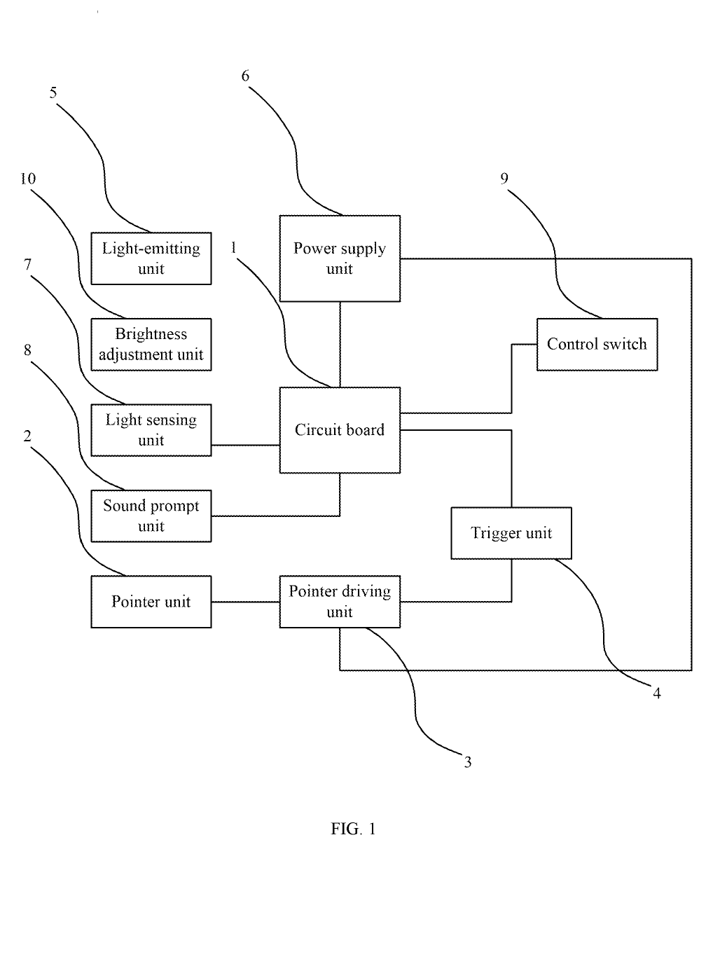

With reference to FIG. 1, a clock control system includes a circuit board 1, where the circuit board 1 is provided with a control unit, further including a pointer unit 2, a pointer driving unit 3, a trigger unit 4, a light-emitting unit 5, and a power supply unit 6, where the pointer driving unit 3 is mechanically connected or inductively connected to the pointer unit 2 and the trigger unit 4, to control the rotation of pointers on the pointer unit 2 and trigger the trigger unit 4 at nodes of integral hours, the light-emitting unit 5 is electrically connected to the control unit through a light-emitting circuit on the circuit board 1, and the power supply unit 6 supplies power to the control unit and the light-emitting unit 5 through a power supply circuit on the circuit board 1.

The pointer unit 2 includes an hour pointer, a minute pointer and a second pointer, and the pointer driving unit 3 drive the hour pointer, the minute pointer and the second pointer to rotate. The trigger unit 4 includes one of a Hall switch, a micro switch, or an optical switch. When the time displayed on the pointer unit 2 reaches a node of an integral hour, the pointer driving unit 3 triggers the trigger unit 4, and when receiving a trigger signal, the trigger unit 4 sends the trigger signal to the control unit. The light-emitting unit 5 includes one of a monochromatic lamp or a multi-color lamp. The control unit controls the light-emitting unit 5 to emit light, and when the light-emitting unit 5 is a monochromatic lamp, light of one color (such as red or blue) can be emitted at each of 24 nodes of integral hours in a day. When the light-emitting unit 5 is a multi-color lamp, such as a tri-color lamp, light of red, blue and green colors can be emitted. A day can be divided into three time segments by eight hours. Colors of light are different in the three time segments. Specifically, red light can be emitted from 8:00 AM to 4:00 PM because it is daytime, green light can be emitted from 4:00 PM to 24:00 PM, and blue light can be emitted from 0:00 AM to 8:00 AM, to create a relatively soft and not glaring atmosphere at night.

In the clock control system, the control unit, the pointer unit 2, the pointer driving unit 3, the trigger unit 4, the light-emitting unit 5, and the power supply unit 6 are arranged in a matched manner. When the hour pointer and the minute pointer of the pointer unit 2 both point to a node of an integral hour in a matched manner, the pointer driving unit 3 triggers the trigger unit 4, the trigger unit 4 sends a signal of the integral hour to the control unit, and the control unit then controls the light-emitting unit 5 to emit light. Light reminds users of nodes of integral hours without need to make a sound, thereby avoiding the possibility of disturbing their rest or sleep at night, so that a good user experience is maintained.

In an embodiment, the clock control system further includes a light sensing unit 7, and the light sensing unit is electrically connected to the control unit; and the light sensing unit 7 includes one of a light-dependent resistor, a diode light sensor, or a transistor light sensor.

The light sensing unit 7 is arranged to achieve a certain function. The light sensing unit 7 sends a brightness value of detected indoor light to the control unit. When the brightness value of the light is greater than a preset threshold, the control unit can control the light-emitting unit 5 to turn off and stop emitting light, and when the brightness value of the light is less than the preset threshold, the control unit can control the light-emitting unit 5 to turn on and start emitting light again.

In an embodiment, the clock control system further includes a sound prompt unit 8, and the sound prompt unit 8 is electrically connected to the control unit.

The sound prompt unit 8 is arranged to achieve a certain function. When the brightness value of the light is greater than the preset threshold, light cannot remind users of integral hours now. In this case, the control unit controls the light-emitting unit 5 to turn off and gives an on-time alarm through the sound prompt unit 8.

In an embodiment, the clock control system further includes a control switch 9, and the control switch 9 is electrically connected to the control unit. When the control switch 9 is turned on, the clock control system is activated, so that the control unit, the pointer unit 2, the pointer driving unit 3, the trigger unit 4, the light-emitting unit 5, and the power supply unit 6 start to work normally.

In an embodiment, the clock control system further includes a brightness adjustment unit 10, a signal input terminal of the brightness adjustment unit 10 is connected to a signal output terminal of the control unit, and a signal output terminal thereof is connected to a signal input terminal of the light-emitting unit 5.

The brightness adjustment unit 10 is mainly configured to adjust the brightness of the light-emitting unit 5. When the light emitted by the light-emitting unit 5 is too bright at late night, users’ sleep is easily affected. Therefore, at a preset time node, the control unit adjusts the brightness of light emitted by the light-emitting unit 5 through the brightness adjustment unit 10, which can ensure that users’ sleep is not affected.

In an embodiment, the sound prompt unit 8 includes one of a speaker or a buzzer.

The foregoing descriptions are merely preferred specific implementations of the present disclosure, and are not intended to limit the protection scope of the present disclosure. Any equivalent replacements or changes made by a person skilled in the art according to the technical solution of the present disclosure and the inventive concepts thereof within the technical scope disclosed in the present disclosure shall fall within the protection scope of the present disclosure.

1. A clock control system, comprising a circuit board, wherein the circuit board is provided with a control unit, further comprising a pointer unit, a pointer driving unit, a trigger unit, a light-emitting unit, and a power supply unit, wherein the pointer driving unit is mechanically connected or inductively connected to the pointer unit and the trigger unit, to control the rotation of pointers on the pointer unit and trigger the trigger unit at nodes of integral hours, the light-emitting unit is electrically connected to the control unit through a light-emitting circuit on the circuit board, and the power supply unit supplies power to the control unit and the light-emitting unit through a power supply circuit on the circuit board.

2. The clock control system according to claim 1, wherein the clock control system further comprises a light sensing unit, and the light sensing unit is electrically connected to the control unit.

3. The clock control system according to claim 1, wherein the clock control system further comprises a sound prompt unit, and the sound prompt unit is electrically connected to the control unit.

4. The clock control system according to claim 1, wherein the clock control system further comprises a control switch, and the control switch is electrically connected to the control unit.

5. The clock control system according to claim 1, wherein the light-emitting unit comprises one of a monochromatic lamp or a multi-color lamp.

6. The clock control system according to claim 1, wherein the trigger unit comprises one of a Hall switch, a micro switch, or an optical switch.

7. The clock control system according to claim 1, wherein the clock control system further comprises a brightness adjustment unit, a signal input terminal of the brightness adjustment unit is connected to a signal output terminal of the control unit, and a signal output terminal thereof is connected to a signal input terminal of the light-emitting unit.

8. The clock control system according to claim 2, wherein the light sensing unit comprises one of a light-dependent resistor, a diode light sensor, or a transistor light sensor.

9. The clock control system according to claim 3, wherein the sound prompt unit comprises one of a speaker or a buzzer.
